(19) United States
(12) Patent Application Publication
(10) Pub. No.: US 2010/0009319 A1
(43) Pub. Date: Jan. 14, 2010

(54) ALLOY AND COMPOSITION FOR ENDODONTIC TREATMENT

(75) Inventor: In-Whan Lee, Seoul (KR)

Correspondence Address: RABIN & Berdo, PC, 1101 14TH STREET, NW, SUITE 500, WASHINGTON, DC, 20005, US

(73) Assignees: Seung-Ho BAEK, Seoul (KR); Syng-Cuk KIM, Brooall, PA (US); In-Whan LEE, Seoul (KR)

(21) Appl. No.: 12/295,138

(22) PCT Filed: Mar. 29, 2007
(86) PCT No.: PCT/KR07/01535

§ 371 Date: Aug. 25, 2009

(30) Foreign Application Priority Data
Mar. 29, 2006 (KR) 10-2006-0028663
Mar. 28, 2007 (KR) 10-2007-0030527

(51) Int. Cl. A61C 5/02

(52) U.S. Cl. 433/224

(57) ABSTRACT

Provided is an alloy for endodontic treatment that can solve a problem of a conventional nitinol alloy. The nitinol alloy has poor mechanical characteristics, such as, tensile strength, yield strength, and elastic modulus and low suitability to a human body. The alloy for endodontic treatment is a Ti-aNb-bSi-based alloy or a Ti-aNb-bGe-based alloy by including silicon (Si) or germanium (Ge) in addition to a binary alloy of titanium (Ti) and niobium (Nb). The alloy for endodontic treatment suggested in the present invention has a small elastic modulus, excellent mechanical characteristics and high suitability to a human body. Moreover, since the strength and flexibility of the alloy can be adjusted selectively, the optimal treatment effect can be acquired according to the conditions of a patient.

### TECHNICAL FIELD

The present invention relates to an alloy and composition for endodontic treatment; and more particularly, to an alloy inserted into a tooth for endodontic treatment. Since the alloy includes silicon (Si) or germanium (Ge) in addition to a binary alloy of titanium (Ti) and niobium (Nb), the alloy becomes a Ti-aNb-bSi-based alloy or a Ti-aNb-bGe-based alloy suitable for a human body and has excellent mechanical characteristics.

### BACKGROUND ART

Conventionally, nitinol has been used as an alloy for endodontic treatment. Nitinol, however, has a problem of poor physical/chemical characteristics, such as tensile strength, yield strength, and elastic modulus.

In addition, an alloy for endodontic treatment should be composed of innoxious alloy elements because it is applied to a human body. Generally, most metallic elements except for Ti, Nb, Ta, Sn, Si and Pt are toxic and thus they are not suitable to be used in a human body.

### DISCLOSURE

Technical Problem

An embodiment of the present invention, which is devised to resolve the above problems, is directed to providing an alloy for endodontic treatment which is suitable to be used in a human body and has a small elastic modulus and excellent mechanical characteristics, compared to conventional alloys for endodontic treatment.

Another embodiment of the present invention is directed to providing an alloy for endodontic treatment whose strength and flexibility can be adjusted selectively according to conditions of a patient to thereby acquire an optimal medical treatment effect.

Technical Solution

In accordance with an aspect of the present invention, there is provided an alloy inserted into a tooth for endodontic treatment, comprising titanium (Ti), niobium (Nb), and silicon (Si) in a form of Ti-aNb-bSi.

In accordance with a first embodiment of the present invention, the alloy has a form of Ti-aNb-bSi and a=26 and b=0.5.

In accordance with a second embodiment of the present invention, the alloy has a form of Ti-aNb-bSi and a=26 and b=1.

In accordance with another aspect of the present invention, there is provided an alloy inserted into a tooth for endodontic treatment, comprising titanium (Ti), niobium (Nb), and germanium (Ge) in a form of Ti-aNb-bGe.

In accordance with a third embodiment of the present invention, the alloy has a form of Ti-aNb-bGe and a=22 and b=1.5.

In accordance with a fourth embodiment of the present invention, the alloy has a form of Ti-aNb-bGe and a=24 and b=1.

In accordance with a fifth embodiment of the present invention, the alloy has a form of Ti-aNb-bGe and a=26 and b=0.5.

### ADVANTAGEOUS EFFECTS

As described above, the present invention provides an alloy for endodontic treatment which has excellent mechanical, physical and chemical characteristics, high suitability for a human body, and a small elastic modulus, compared to conventional alloys for endodontic treatment, and a composition for preparing the alloy. Since the strength and flexibility of the alloy can be adjusted selectively, the alloy and the composition therefor can bring about optimal medical treatment effect according to the conditions of a patient.

### BRIEF DESCRIPTION OF THE DRAWINGS

FIG. 1 is a graph showing a variance of a bond order (Bo) for each alloy element added to titanium (Ti), and metallic d-orbital energy potential (Md).

FIG. 2 is a graph showing a elastic modulus and a balanced-unbalanced state of Ti-niobium (Nb)-based alloy quenched at 1000° C.

FIG. 3 is a Bo-Md map showing a bond order (Bo) and a metallic d-orbital energy potential (Md), the Bo-Md map illustrating a region of α, α+β, and β shown in FIG. 2 to design a Ti-based alloy with a small elastic modulus.

FIG. 4 is a graph showing an effect of silicon (Si) on the tensile strength of a Ti—Nb—Si-based alloy.

FIG. 5 is a graph showing an effect of Si on the yield strength of the Ti—Nb—Si-based alloy.

FIG. 6 is a graph showing an effect of Si on the elastic modulus of the Ti—Nb—Si-based alloy.

FIG. 7 is a table showing mechanical characteristics of Ti-26Nb-0.5Si in accordance with a first embodiment of the present invention.

FIG. 8 is a table showing mechanical characteristics of Ti-26Nb-1.0Si in accordance with a second embodiment of the present invention.

FIG. 9 is a graph showing effects of Nb and germanium (Ge) on the tensile strength of the Ti—Nb—Ge-based alloy.

FIG. 10 is a graph showing the effects of Nb and Ge on the yield strength of the Ti—Nb—Ge-based alloy.

FIG. 11 is a graph showing the effects of Nb and Ge on the elastic modulus of the Ti—Nb—Ge-based alloy.

FIG. 12 is a table showing mechanical characteristics of Ti-22Nb-1.5Ge in accordance with a third embodiment of the present invention.

FIG. 13 is a table showing mechanical characteristics of Ti-24Nb-1.0Ge in accordance with a fourth embodiment of the present invention.

FIG. 14 is a table showing mechanical characteristics of Ti-26Nb-0.5Ge in accordance with a fifth embodiment of the present invention.

FIG. 15 is a graph describing an anti-corrosion property of a Ti—Nb-based alloy in accordance with an embodiment of the present invention.

FIG. 16 is a graph describing a cell survival rate of the Ti—Nb-based alloy in accordance with the embodiment of the present invention.

FIG. 17 is a general comparison table comparing a Ti—Nb—Si-based alloy and a Ti—Nb—Ge-based alloy of the present invention with a conventional nitinol-based alloy with respect to mechanical characteristics and suitability to a human body.

### BEST MODE FOR THE INVENTION

Hereinafter, structures, functions and effects of an alloy for endodontic treatment and a composition therefor will be described in detail according to specific embodiments of the present invention.

An alloy for endodontic treatment is composed of innoxious metallic elements because it is applied to a human body. Thus, the alloy has a small elastic modulus and excellent mechanical characteristics, compared to conventional alloys for endodontic treatment. Also, the elastic modulus signifies weight needed for unit deformation in an elasticity deformation section. A small elastic modulus means that much elasticity deformation occurs with a little amount of force, or a little force is needed for the same elasticity deformation. Therefore, the elastic modulus is a significant factor in preparing an alloy for endodontic treatment, which is the art of the present invention.

The alloy satisfying the aforementioned conditions is designed based on an electron structure of a metallic atom.

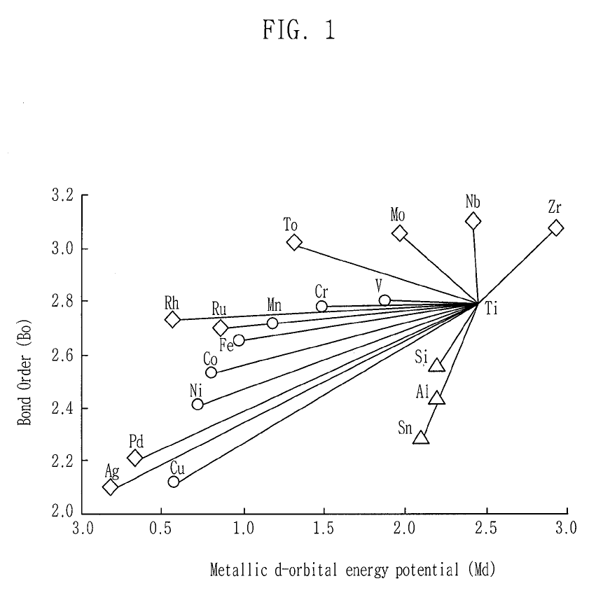

FIGS. 1 to 3 are graphs showing variance in a bond order (Bo) for an alloy element added to titanium (Ti) and a metallic d-orbital energy potential (Md). As shown in the drawing, a Ti-based alloy is designed based on an electron structure by using a Bo-Md map of the bond order and the metallic d-orbital energy potential (Md).

The bond order is a value indicating overlapped electron distribution between atoms and it is an index for covalent bond between atoms. The metallic d-orbital energy potential (Md) is a factor related to an atom radius and electronegativity. The smaller the atom radius is and the larger the electronegativity is, the smaller the metallic d-orbital energy potential (Md) becomes.

To be specific, the Bo-Md map of FIGS. 1 to 3 shows that the variance has four types according to the kind of an alloy element added to Ti. The first one is represented by zinc (Zr), which is an element that increases both the bond order and the metallic d-orbital energy potential. The second one is represented by Nb, which is an element that increases the bond order while not varying the metallic d-orbital energy potential (Md) remarkably. The third one is represented by molybdenum (Mo) and technetium (Tc), which are elements that decrease the metallic d-orbital energy potential (Md) while increasing the bond order. The fourth one is represented by 5A to 1B elements of the third period, 8A to 1B elements of the fourth period, and typical elements, which are elements that decrease both the bond order and the metallic d-orbital energy potential.

The smaller the number of overlapped electrons is, the weaker the bond force between the atoms becomes.

Thus, the elastic modulus decreases. Also, the higher the metallic d-orbital energy potential (Md) is, that is, as the atom radius becomes long and the electronegativity becomes small, the smaller the elastic modulus is.

For this reason, the alloy should be designed in a direction that the bond order becomes small and the metallic d-orbital energy potential (Md) becomes large in the Bo-Md map.

When a Ti-based alloy is designed, the elastic modulus is affected not only by the bond order and the metallic d-orbital energy potential (Md) but by a structure as well.

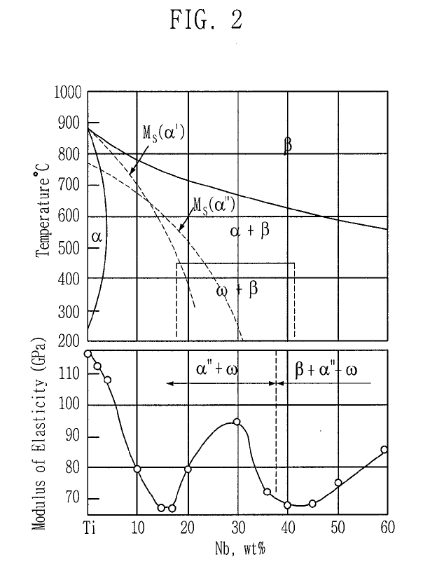

FIG. 2 is a graph showing a elastic modulus and a balanced-unbalanced state of Ti-niobium (Nb)-based alloy quenched at 1000° C. As shown in the drawing, Ti is an allotropic transformation element having an hcp structure (α phase) at a temperature lower than 863° C. and a bcc structure ((β phase) at a temperature higher than 863° C. Intrinsically, the α phase is stable at a room temperature but the Ti-based ally may be present at the room temperature in the phase of α+β or complete β by adding a stabilizer for stabilizing the β phase sufficiently.

Balanced phases of the Ti—Nb-based alloy are α and β but an α′ phase (hcp), an α″ phase (orthorhombic), and an ω (hcp) phase may appear from the quenching. The Ti—Nb-based alloy has a remarkably varying elastic modulus according to the phase. In particular, the elastic modulus is the lowest at around 40 wt % Nb where the major phase is β. The elastic modulus increases, as the content of Nb increases gradually.

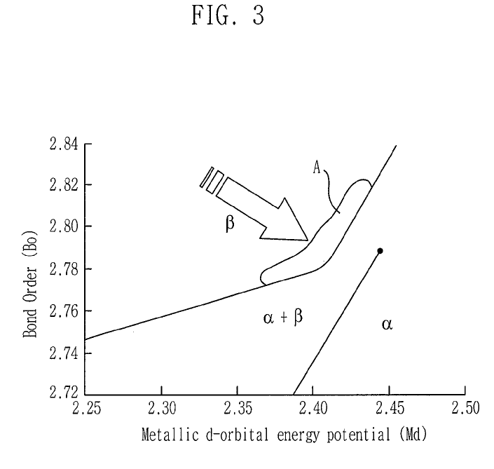

FIG. 3 is a Bo-Md map showing a bond order (Bo) and a metallic d-orbital energy potential (Md). The Bo-Md map illustrates a region of α, α+β, and β shown in FIG. 2 to design a Ti-based alloy with a small elastic modulus.

Referring to the drawing, the semi-stable region of the β phase is a boundary between the α+β phase and the β phase, and the direction for reducing the bond order and the metallic d-orbital energy potential, which is described above, is represented as an arrow mark. It can be seen from the drawing that a region A is a region where a small elastic modulus can be acquired.

To satisfy the above conditions, the Ti—Nb-based alloy is pulled up to the β phase in the Bo-Md map by adding a strong β-phase stabilizing agent, e.g., Nb, Mo and tantalum (Ta), and the bond order is reduced while the semi-stable β phase is maintained by adding a secondary element, e.g., Si, germanium (Ge) and stannum (Sn), to the Ti—Nb-based alloy. After all, the Ti-based alloy having a smaller elastic modulus than conventional alloys for endodontic treatment in a human body is a ternary alloy including Si or Ge in addition to the binary Ti—Nb alloy, i.e., Ti—Nb—Si or Ti—Nb—Ge alloy.

Hereinafter, the mechanical characteristics of the Ti—Nb—Si-based or Ti—Nb—Ge-based alloy for endodontic treatment will be detected by measuring tensile strength, yield strength, and elastic modulus, and the optimal content ratio of the Ti—Nb—Si-based or Ti—Nb—Ge-based alloy will be determined in accordance with an embodiment of the present invention.

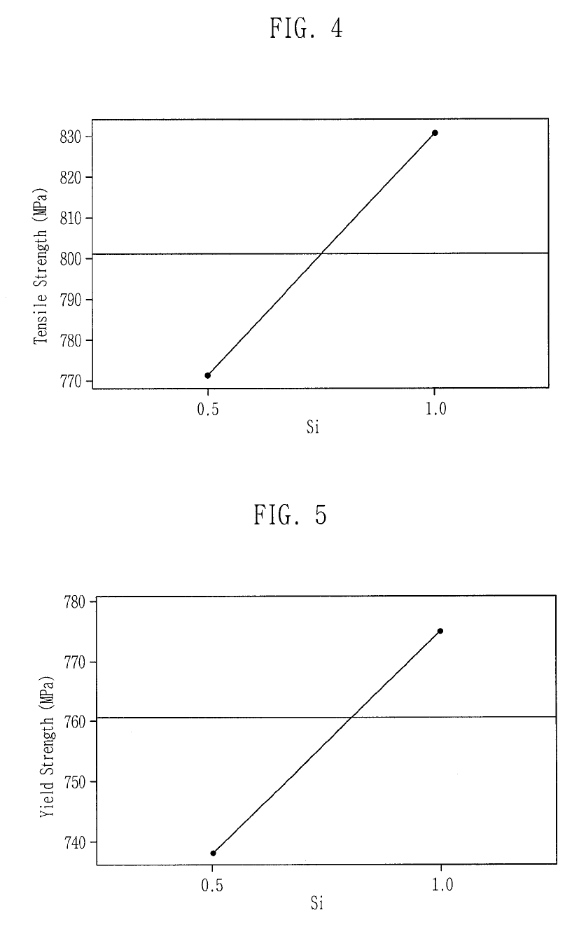

FIG. 4 is a graph showing an effect of Si on the tensile strength of a Ti—Nb—Si-based alloy. As shown in the drawing, when the Si content is 0.5 in the Ti—Nb—Si-based alloy, the tensile strength is 771.67 (MPa). When the Si content is 1.0, the tensile strength is 830.67 (MPa). Therefore, it can be seen that the tensile strength increases in the Ti—Nb—Si-based alloy, as the Si content increases.

FIG. 5 is a graph showing an effect of Si on the yield strength of the Ti—Nb—Si-based alloy. As shown in the drawing, when the Si content is 0.5 wt % in the Ti—Nb—Si-based alloy, the yield strength is 738.00 (MPa). When the Si content is 1.0 wt %, the yield strength is 775.33 (MPa). Therefore, variance in the Si content insignificantly affects the variance in the yield strength of the Ti—Nb—Si-based alloy in consideration of dispersion. In short, the Si content does not affect the variance of the yield strength.

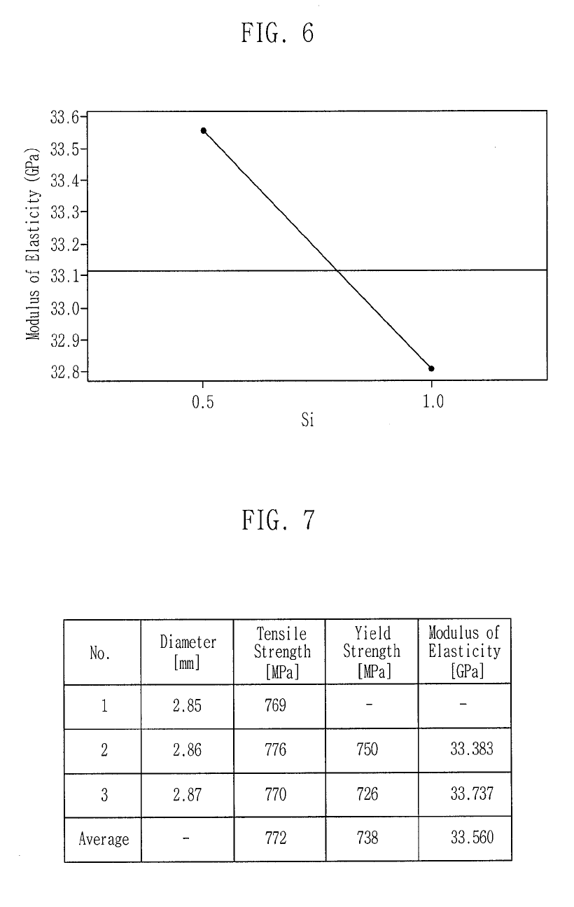

FIG. 6 is a graph showing an effect of Si on the elastic modulus of the Ti—Nb—Si-based alloy. As shown in the drawing, when the Si content is 0.5 wt %, the elastic modulus is 33.560 GPa. When the Si content is 1.0 wt %, the elastic modulus is 32.812 GPa. Therefore, the variance in the Si content insignificantly affects the variance in the elastic modulus of the Ti—Nb—Si-based alloy in consideration of dispersion. In short, the Si content does not affect the variance of the elastic modulus.

As described above, the variance in the mechanical characteristics caused by the variance in the Si content affects the tensile strength of the Ti—Nb—Si-based alloy and does not significantly affect the yield strength and elastic modulus.

FIG. 7 is a table showing mechanical characteristics of Ti-26Nb-0.5Si in accordance with a first embodiment of the present invention. To measure the mechanical characteristics, a Ti—Nb—Si-based alloy sample went through solution treatment and rod milling to thereby produce a line sample having a diameter of about 2.9 mm. The line sample was tested for tensile strength. Three samples of the same material were tested and assayed.

As shown in the drawing, the three tests averaged a tensile strength of 772 MPa, a yield strength of 738 MPa, and a elastic modulus of 33.56 GPa.

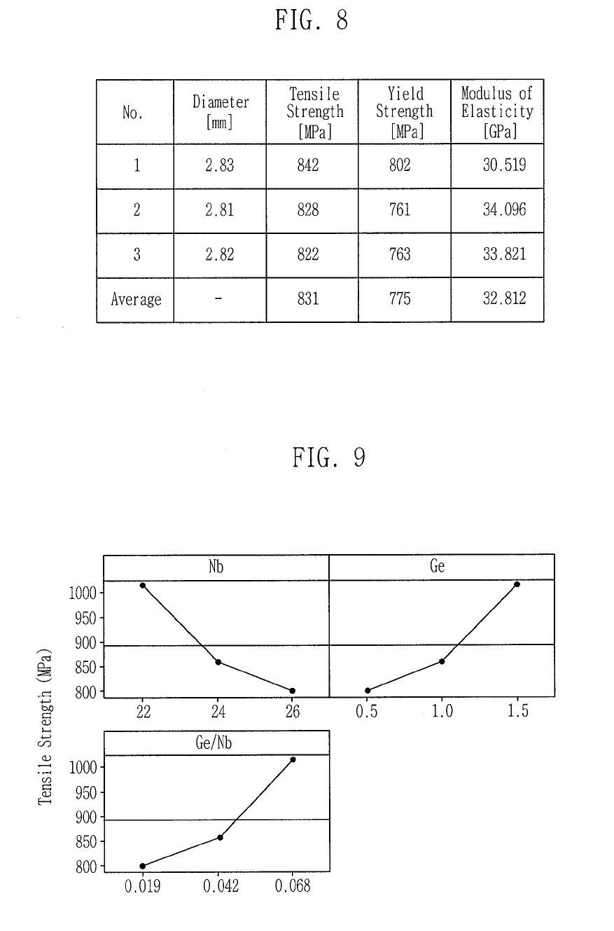

FIG. 8 is a table showing mechanical characteristics of Ti-26Nb-1.0Si in accordance with a second embodiment of the present invention. The mechanical characteristics were tested and assayed according to the same measurement method as that of FIG. 8. The three tests averaged a tensile strength of 831 MPa, a yield strength of 775 MPa, and a elastic modulus of 32.812 GPa.

Accordingly, the Ti-26Nb-0.5Si of the first embodiment and the Ti-26Nb-1.0Si of the second embodiment have small elastic modulus values and excellent mechanical characteristics, compared to conventional alloys for endodontic treatment.

FIG. 9 is a graph showing effects of Nb and germanium (Ge) on the tensile strength of the Ti—Nb—Ge-based alloy. As shown in the drawing, the tensile strength decreases as the Nb content increases gradually into 22 wt %, 24 wt %, and 26 wt %. The tensile strength improves, as the Ge content increases gradually into 0.5 wt %, 1.0 wt %, and 1.5 wt %. Also, the tensile strength improves, as a Ge/Nb ratio increases gradually into 0.019, 0.042 and 0.068.

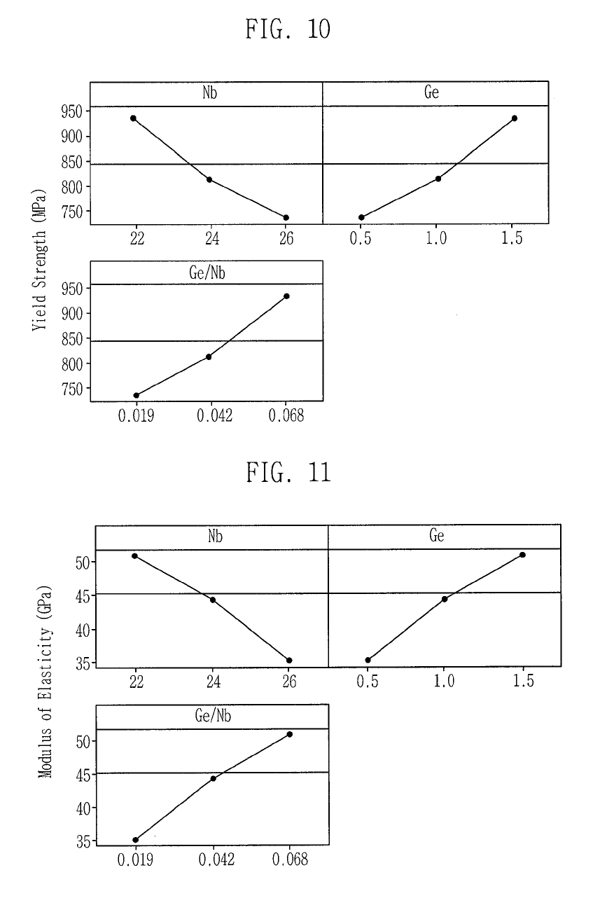

FIG. 10 is a graph showing the effects of Nb and Ge on the yield strength of the Ti—Nb—Ge-based alloy. As shown in the drawing, the yield strength decreases as the Nb content increases gradually into 22 wt %, 24 wt %, and 26 wt %. The yield strength improves, as the Ge content increases gradually into 0.5 wt %, 1.0 wt %, and 1.5 wt %. Also, the yield strength improves, as a Ge/Nb ratio increases gradually into 0.019, 0.042 and 0.068.

FIG. 11 is a graph showing the effects of Nb and

Ge on the elastic modulus of the Ti—Nb—Ge-based alloy. As shown in the drawing, the elastic modulus decreases as the Nb content increases gradually into 22 wt %, 24 wt %, and 26 wt %. The elastic modulus improves, as the Ge content increases gradually into 0.5 wt %, 1.0 wt %, and 1.5 wt %. Also, the elastic modulus improves, as the Ge/Nb ratio increases gradually into 0.019, 0.042 and 0.068.

As described above, it is possible to design a Ti—Nb—Ge-based alloy having the optimal contents based on the variance in the mechanical characteristics caused by the variance in the contents of Nb and Ge.

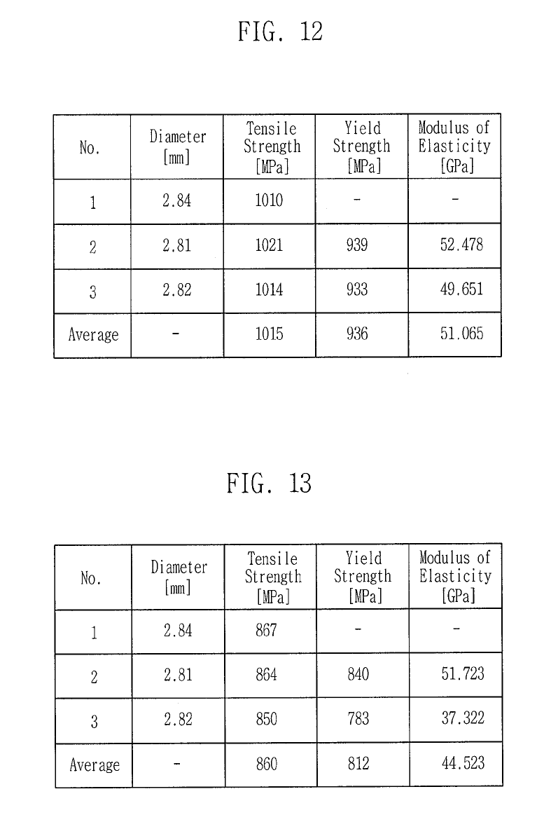

FIG. 12 is a table showing mechanical characteristics of Ti-22Nb-1.5Ge in accordance with a third embodiment of the present invention. To measure the mechanical characteristics, a Ti—Nb—Ge-based alloy sample went through solution treatment and rod milling to thereby produce a line sample having a diameter of about 2.9 mm. The line sample was tested for tensile strength. Three samples of the same material were tested and assayed.

As shown in the drawing, the three tests averaged a tensile strength of 1015 MPa, a yield strength of 936 MPa, and a elastic modulus of 51.065 GPa.

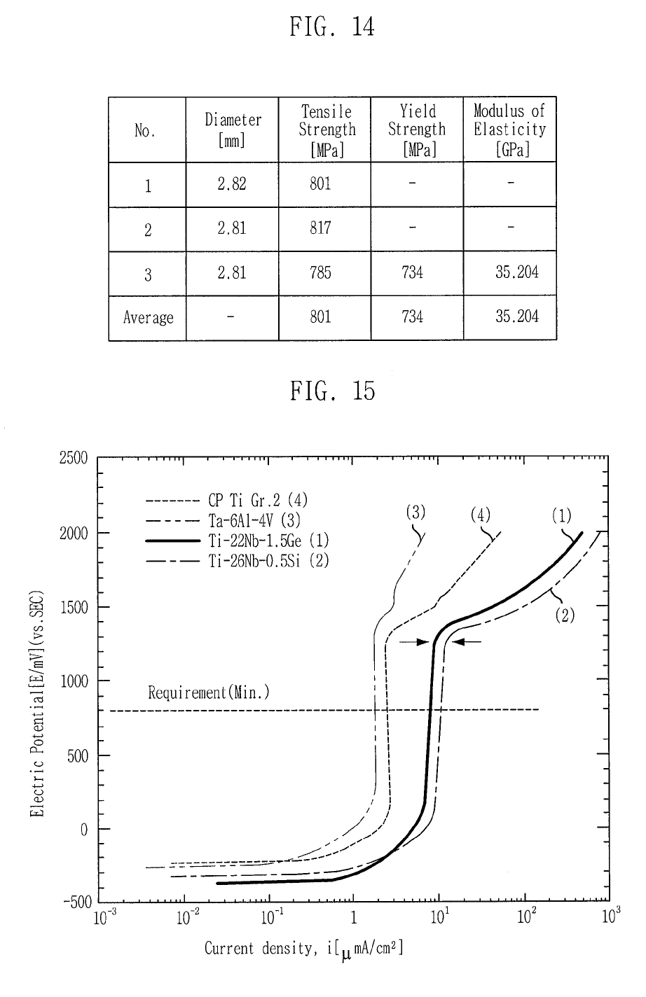

FIG. 13 is a table showing mechanical characteristics of Ti-24Nb-1.0Ge in accordance with a fourth embodiment of the present invention. The mechanical characteristics were tested and assayed according to the same measurement method as that of FIG. 14 described above. The three tests averaged a tensile strength of 860 MPa, a yield strength of 812 MPa, and a elastic modulus of 44.523 GPa.

FIG. 14 is a table showing mechanical characteristics of Ti-26Nb-0.5Ge in accordance with a fifth embodiment of the present invention. The mechanical characteristics were tested and assayed according to the same measurement method as that of FIG. 14 described above. The three tests averaged a tensile strength of 801 MPa, a yield strength of 734 MPa, and a elastic modulus of 35.204 GPa.

Accordingly, the Ti-26Nb-1.5Ge of the third embodiment, the Ti-26Nb-1.0Ge of the fourth embodiment, and the Ti-26Nb-0.5Ge of the fifth embodiment have small elastic modulus values and excellent mechanical characteristics, compared to the conventional alloys for endodontic treatment.

FIG. 15 is a graph describing an anti-corrosion property of a Ti—Nb-based alloy in accordance with an embodiment of the present invention. As shown in the drawing, the anti-corrosion property was measured based on ASTM F2129. The Ti-26Nb-0.5S1(2) of the first embodiment, the Ti-26Nb-1.5Ge(1) of the third embodiment, and commercial alloys CP-Ti-Gr.2(4) and Ti-6A1-4V(3) were tested for an anti-corrosion experiment. The experimental result was that the Ti-26Nb-0.5Si and the

Ti-26Nb-1.5Ge have superior anti-corrosion property.

FIG. 16 is a graph describing a cell survival rate of the Ti—Nb-based alloy in accordance with the embodiment of the present invention. The graph shows an MTT assay test result. Referring to the drawing, the Ti-26Nb-0.5Si of the first embodiment and the Ti-26Nb-1.5Ge of the third embodiment show high cell survival rates of over 90%, compared with a control group.

Since the Ti—Nb—Si alloy and the Ti—Nb—Ge alloy of the present invention, which are prepared by adding Si or Ge to a Ti—Nb-based alloy, satisfy both conditions of excellent mechanical characteristics and high suitability to a human body, they can be used as alloys for endodontic treatment.

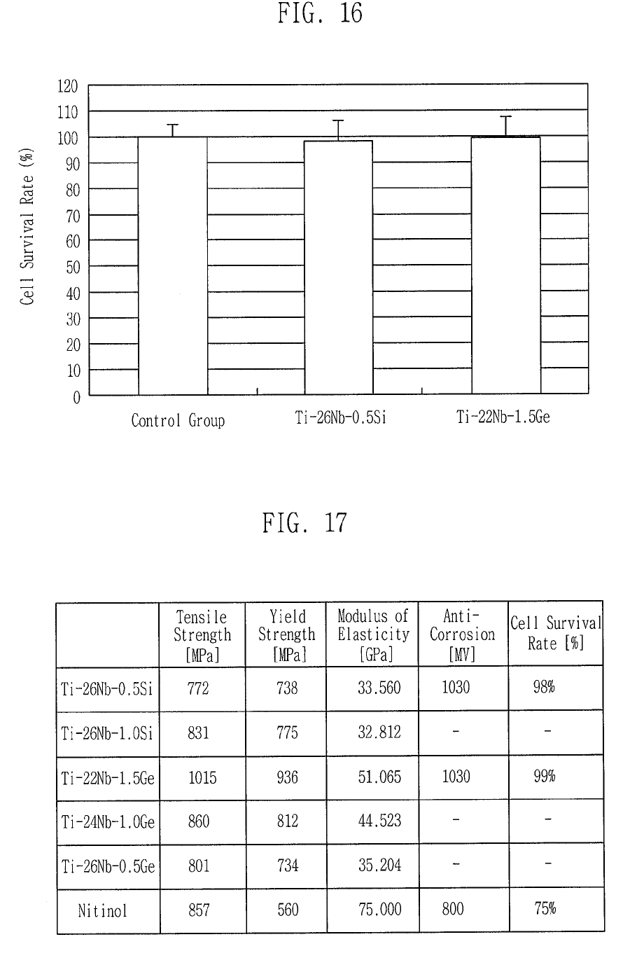

FIG. 17 is a general comparison table comparing a Ti—Nb—Si-based alloy and a Ti—Nb—Ge-based alloy of the present invention with a conventional nitinol-based alloy with respect to mechanical characteristics and suitability to a human body. As shown in the drawing, the conventional nitinol alloy has a elastic modulus of 75 GPa, whereas the Ti—Nb—Si-based alloy and a Ti—Nb—Ge-based alloy of the present invention have a small elastic modulus value ranging from 32.812 GPa to 51.065 GPa. This signifies that when the alloys of the present invention have the same yield strength as that of the nitinol alloy, the elasticity deformation range can increase more than about twice. Also, when the alloys of the present invention have a half as high yield strength as the nitinol alloy, the alloys of the present invention can have the same elasticity deformation range.

In addition, whereas the nitinol alloy has a yield strength of 560 MPa, the Ti-26Nb-0.5Si alloy, the Ti-26Nb-1.0Si alloy, the Ti-22Nb-1.5Ge alloy, the Ti-24Nb-1.0Ge alloy, and the Ti-24Nb-0.5Ge have yield strengths of 738 MPa, 775 MPa, 936 MPa, 812 MPa, and 734 MPa, respectively, according to the first to fifth embodiments of the present invention. The above alloys of the present invention have higher yield strengths than the nitinol alloy.

Whereas the nitinol alloy has an tensile strength of 560 MPa, the Ti-26Nb-0.5Si alloy, the Ti-26Nb-1.0Si alloy, the Ti-22Nb-1.5Ge alloy, and the Ti-24Nb-1.0Ge, and the Ti-24Nb-0.5Ge have yield strengths of 772 MPa, 831 MPa, 1015 MPa, 860 MPa, and 801 MPa, respectively, according to the first to fifth embodiments of the present invention. The above alloys of the present invention have higher tensile strengths than the nitinol alloy.

As for the anti-corrosion property, the nitinol alloy has an anti-corrosion property of 800 MV, the Ti-26Nb-0.5Si alloy of the first embodiment is 1030 MV, and the Ti-22Nb-1.5Ge alloy of the third embodiment is 1030 MV. The alloys of the first and third embodiments of the present invention have superior anti-corrosion property to the nitinol alloy.

As for the cell survival rate, the nitinol alloy has a cell survival rate of 75%, the Ti-26Nb-0.5Si alloy of the first embodiment is 98%, and the Ti-22Nb-1.5Ge alloy of the third embodiment is 99%. The alloys of the first and third embodiments of the present invention have superior cell survival rate to the nitinol alloy.

In consequences, the alloy for endodontic treatment suggested in the present invention includes Si or Ge in addition to a binary alloy of Ti and Nb. The Ti—Nb—Si-based or Ti—Nb—Ge-based alloy has a small elastic modulus and excellent mechanical characteristics and suitability to a human body, compared to the conventional nitinol alloy. Since the small elastic modulus is one of the important requirements in the alloy for endodontic treatment, which is the art of the present invention, it can be concluded that the alloy for endodontic treatment suggested in the present invention solves the problem of conventional technology.

Also, since it is possible to selectively realize the strength and flexibility of the alloy for endodontic treatment suggested in the present invention, the optimal medical treatment effect can be acquired by controlling them according to the conditions of a patient.

The present application contains subject matter related to Korean Patent Application Nos. 10-2006-0028663 and 10-2007-0030527, filed in the Korean Intellectual Property Office on Mar. 29, 2006, and Mar. 28, 2007, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. An alloy inserted into a tooth for endodontic treatment, comprising titanium (Ti), niobium (Nb), and silicon (Si) in a form of Ti-aNb-bSi.

2. The alloy of claim 1, wherein a=26 and b=0.5.

3. The alloy of claim 1, wherein a=26 and b=1.

4. An alloy inserted into a tooth for endodontic treatment, comprising titanium (Ti), niobium (Nb), and germanium (Ge) in a form of Ti-aNb-bGe.

5. The alloy of claim 4, wherein a=22 and b=1.5.

6. The alloy of claim 4, wherein a=24 and b=1.

7. The alloy of claim 4, wherein a=26 and b=0.5.

8. A composition inserted into a tooth for endodontic treatment, comprising titanium (Ti), niobium (Nb), and silicon (Si).

9. A composition inserted into a tooth for endodontic treatment, comprising titanium (Ti), niobium (Nb), and germanium (Ge).
